(19) United States
(12) Patent Application Publication
(10) Pub. No.: US 2003/0164219 A1
(43) Pub. Date: Sep. 4, 2003

(54) Headliner/duct assembly and welding process therefor

(76) Inventors: Joerg Brahm, Limburg (DE); Robert Gifford, Grand Blanc, MI (US)

Correspondence Address: HARNESS, DICKEY & PIERCE, P.L.C., P.O. BOX 828, BLOOMFIELD HILLS, MI, 48303, US

(21) Appl. No.: 10/340,055

(22) Filed: Jan. 10, 2003

Related U.S. Application Data
(63) Continuation-in-part of application No. 10/210,161, filed on Aug. 1, 2002.
(60) Provisional application No. 60/358,123, filed on Feb. 20, 2002.

(51) Int. Cl. B32B 35/00

(52) U.S. Cl. 156/73.5; 156/73.1

(57) ABSTRACT

A headliner/duct assembly for a vehicle is made by vibration welding the headliner and duct together or ultrasonically welding the headliner and duct of the assembly together. Parts made of materials that are incompatible for ultrasonic welding can be ultrasonically welded together by first adhering to one part compatible material that is compatible with the other part.

### CROSS-REFERENCE TO RELATED APPLICATIONS

This application is a continuation-in-part of U.S. patent application Ser. No. 10/210,161 for Energy Management System and Welding Process Therefor filed Aug. 1, 2002, which in turns claims the benefit of U.S. Provisional Application No. 60/358,123 filed Feb. 20, 2002.

### FIELD OF THE INVENTION

The present invention relates to air duct systems in used in vehicles and to a process used to manufacture them.

### BACKGROUND OF THE INVENTION

In today's vehicle's, such as automotive vehicles, ducts are used to distribute air to the passenger compartment. In some vehicles, the ducts run from the vehicles HVAC (heating, ventilation, air conditioning) system into the instrument panel and connect to outlets in the instrument panels. In other vehicles, in addition to running to outlets in the instrument panels, the ducts run underneath the floor of the vehicles and open in the rear of the vehicle. In yet other vehicles, ducts are routed between the headliner of the vehicle and the vehicles roof and open to outlets at desired locations in the passenger compartment.

In vehicles where the ducts run between the headliner and the vehicles' roof, the duct and headliner are preferably secured together. This is typically done by gluing the duct and headliner together at appropriate locations.

With reference to FIG. 1, one type of headliner 10 is made of a layer 12 of polyurethane or polypropylene foam having a polyester or polypropylene backing sheet 14 and a front sheet 16 of fabric presenting a good appearance, such as felt, for the surface that is visible when the part is installed in a vehicle (referred to herein as the visible surface). In the context of automotive applications, the visible surface of a part is referred to as the “Class A” surface. Polyester/polypropylene backing sheet 14 and front sheet 16 are typically bonded to polyurethane/polypropylene foam layer 12 by adhesive.

Gluing ducts and headliners together presents a number of challenges. The glue must bond to both the duct material and the headliner material and provide a sufficiently strong and durable bond to hold the two together for the expected life of the vehicle. Such glues tend to be expensive so minimizing the amount of glue used is desirable. Consequently, the glue is typically applied to only portions of the duct and headliner. Glue application is also cumbersome and adds time to the manufacturing process, which in turn adds cost.

Headliners may also include energy management systems. As used herein, an “energy management system” is a structure that has a substrate bonded to an energy absorbing pad or crash pad, such as a honeycomb structure. The crash pad, such as polypropylene honeycomb structures, polypropylene rib structures, or other crash pad structures, are illustratively bonded to the headliner at the appropriate locations. FIG. 2 is an exploded view of such a headliner/crash pad energy management system in which crash pads 18 are bonded to headliner 10 by adhesive. In the resulting headliner/crash pad energy management system, the headliner is the substrate and the crash pad is the polypropylene honeycomb structure, polypropylene rib structure, or other crash pad structure.

### SUMMARY OF THE INVENTION

In accordance with an aspect of the invention, a headliner/duct assembly for a vehicle is made by vibration welding the headliner and duct of the assembly together. In accordance with another aspect of the invention, a headliner/duct assembly for a vehicle is made by ultrasonically welding the headliner and duct of the assembly together.

In an aspect of the invention, the headliner can be part of an energy management system.

In an aspect of the invention, the headliner and duct are made of materials incompatible with each other for vibration welding. A layer of compatible material compatible with one of the headliner and duct is adhered to the other of the headliner and duct prior to vibration welding.

In an aspect of the invention, parts made of materials that are incompatible for ultrasonic welding can be ultrasonically welded together by first adhering to one part compatible material that is compatible with the other part prior to ultrasonically welding the two parts together.

In an aspect of the invention, the headliner and duct are made of materials incompatible with each other for ultrasonic welding. A layer of compatible material compatible with one of the headliner and duct is adhered to the other of the headliner and duct prior to ultrasonic welding.

### BRIEF DESCRIPTION OF THE DRAWINGS

The present invention will become more fully understood from the detailed description and the accompanying drawings, wherein:

FIG. 1 is an exploded view of a prior art headliner;

FIG. 2 is an exploded view of a prior art headliner energy management system;

FIG. 3 is a side view of an energy management system in a vibration welding apparatus;

FIG. 4 is an exploded view of an energy management system that has been vibration welded together;

FIG. 5 is an exploded view of an energy management system that has been vibration welded together;

FIG. 6 is a side view of a polypropylene rib structure;

FIG. 7 is a side view of welded sandwich polypropylene honeycomb structure;

FIG. 8 is a graphical illustration of a polymer joint formed by vibration welding;

FIG. 9 is a graphical illustration of a mechanical joint formed by vibration welding; and

FIG. 10 is a side view of a duct and headliner made in accordance with an aspect of the invention shown installed in a motor vehicle;

FIG. 11 is a side view of a duct and headliner in a vibration welding apparatus;

FIG. 12 is a side view of a duct and headliner in an ultrasonic welding apparatus; and

FIG. 13 is a chart showing compatibility of materials for ultrasonic welding.

### DETAILED DESCRIPTION OF THE PREFERRED EMBODIMENTS

The following description of the preferred embodiments is merely exemplary in nature and is in no way intended to limit the invention, its application, or uses.

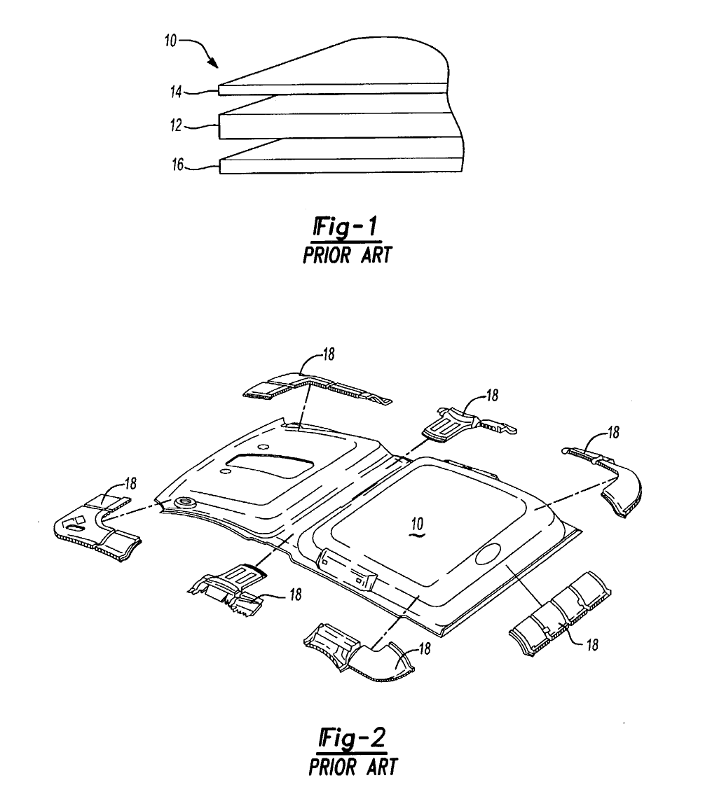

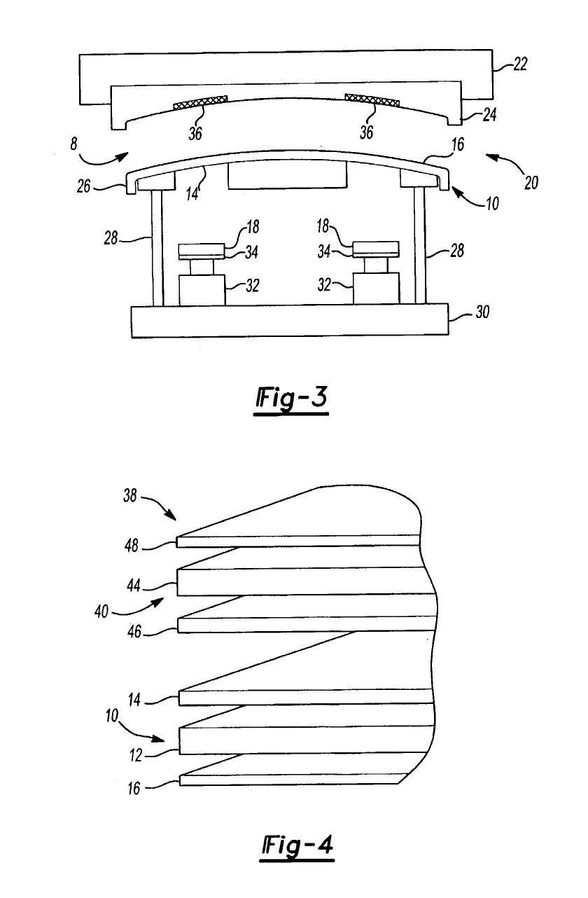

Referring to FIG. 3, a process of vibration welding a headliner/crash pad energy management system 8 is described. Headliner/crash pad energy management system 8 comprises headliner 10 (FIG. 1) bonded to crash pad 18. Crash pad 18 is illustratively a polypropylene honeycomb structure. It should be understood that crash pad 18 can be other crash pad structures, such as polypropylene rib structure 56 (FIG. 6). As is known, polypropylene rib structure 56 is a structure molded from polypropylene to have ribs 58 for absorbing impact.

In FIG. 3, a friction or vibration welding apparatus 20 has a vibration head 22 having an upper tool 24 mounted thereto. Vibration welding apparatus 20 further has a lower pre-centering fixture 26 supported by cylinders 28 mounted on table 30. Vibration welding apparatus 20 also includes pressure zones 32 having crash pad receiving fixtures 34. Pressure zones 32 can illustratively be VS-8101/1, VS-8101/2 or VS-8101/7 pressure zones available from Branson Ultrasonics of Rochester Hills, Mich. Roughened inserts 36, such a knurled aluminum inserts, are mounted in upper tool 24.

Vibration welding apparatus 20 may illustratively be a vibration welding apparatus of the type disclosed in U.S. Pat. No. 3,920,504 for a Friction Welding Apparatus, the entirety of which is incorporated by reference herein.

Headliner 10 is loaded onto pre-centering fixture 26 with the visible (fabric layer 16) of the headliner face up. Crash pads 18 are placed on crash pad fixtures 34 and the welding cycle of vibration welding apparatus 20 initiated. Table 30 raises cylinders 28 and pressure zones 32, bringing headliner 10 into upper tool 24 with pressure zones 32 forcing crash pads 18 against polyester backing layer 14 of headliner 10. When headliner 10 has been raised into upper tool, pre-centering fixture 26 is lowered. Vibration head 22 is then actuated vibrating the crash pad 18 against polyester backing sheet 14 of headliner 10 to vibration weld crash pads 18 to headliner 10. Roughened inserts 36 are positioned in upper tool 24 so that they are opposite crash pads 18 when headliner 10 has been raised into upper tool 24 and crash pads 18 are forced against headliner 10 by pressure zones 32. Upon completion of the vibration weld cycle, vibration welding apparatus 20 maintains crash pads 18 against headliner 10 under pressure for an appropriate hold time. Upon expiration of the hold time, table 30 is lowered and the completed headliner/crash pad energy management system 8 is removed from vibration welding apparatus 20.

It should be understood that vibration welding apparatus 20 can be configured so that crash pads 18 are raised into upper tool 24 and headliner 10 raised up against crash pads 18.

The vibration of one part against the other, in this case, the polypropylene honeycomb structure which is illustratively crash pad 18, against the polyester backing sheet 14 of headliner 10 causes sufficient frictional heat to melt the polypropylene thermoplastic of crash pad 18 and the thermoplastic of the polyester backing layer 14 of headliner 10 together creating one or both of a polymer joint and mechanical joint (interlocking) depending on the respective compositions of crash pad 18 and polyester backing layer 14. With polypropylene backing, the bond is essentially a polymer bond and with polyester backing, the bond is essentially a mechanical bond where the thermoplastic of the polypropylene honeycomb crash pads 18 around the fibers of the polyester backing layer 14 (interlocking). It should be understood that crash pads 18 can be other than polypropylene honeycomb structures, such as foam or polypropylene rib structures.

The above described process can be conducted using known friction or vibration welding apparatus, such as that described in the aforementioned U.S. Pat. No. 3,920,504. The welding parameter conditions are modified according to the materials of which the two parts to be welded are made to achieve appropriate vibration or friction welding of the two parts. The welding parameters of significance include pressure, amplitude, frequency, weld time and hold time.

The polypropylene honeycomb structure that is illustratively crash pad 18 can illustratively be any of the polypropylene honeycombs sold under the trade name TRAUMA-LITE Honeycombs by Trauma Lite Ltd., of Manchester, United Kingdom, the PP 8-80 TUBUS Honeycombs—Polypropylene sold by ATS, Inc. of Canonsburg, Pa., and the WAVECORE® polypropylene honeycombs sold by ATS, Inc. Illustrative welding parameters for welding polyester backed headliner material to such polypropylene honeycomb structures using a Branson Ultrasonics Mini-Vibration Welder available from Branson Ultrasonics are:

| | |
|---|---|
| Maximum Clamp Load: | 331 N-340 N |
| Weld Amplitude | 1.70-180 mm (peak-to-peak) |
| Weld Time | 1-8 sec. |
| Weld Frequency | 240 Hz. |

Table 1 shows welding parameters for a Branson Ultrasonics MINI-VIBRATION WELDER used to weld pieces of such headliner material to such honeycomb structures in which a bond was achieved. The weld parameters for achieving satisfactory and optimal bonds can be determined by routine trials. (Honeycomb material with 10 mm and 20 mm thickness (70 mm×700 mm), headliner material with and without foam inside and polyester backing.)

TABLE 1

| | Fre- | | Weld | Melt | Hold | Hold | |
|---|---|---|---|---|---|---|---|
| | quency | Amplitude | Force | Time | Force | Time | |
| Part # | [Hz] | [mm] | [N] | [sec] | [sec] | [sec] | Comments |
| 1 | 240 | 1.80 | 340 | 5 | 340 | 5 | 10 mm/without |
| | | | | | | | foam backing |
| 2 | 240 | 1.80 | 340 | 8 | 340 | 5 | 10 mm/without |
| | | | | | | | foam backing |
| 3 | 240 | 1.80 | 340 | 8 | 340 | 5 | 10 mm/without |
| | | | | | | | foam backing |
| 4 | 240 | 1.80 | 340 | 8 | 340 | 5 | 20 mm/with |
| | | | | | | | foam backing |
| 5 | 240 | 1.80 | 340 | 8 | 340 | 8 | 20 mm/with |
| | | | | | | | foam backing |
| 6 | 240 | 1.80 | 340 | 5 | 340 | 5 | 10 mm/with |
| | | | | | | | foam backing |

Table 2 shows welding parameters for a Branson Ultrasonics MINI-VIBRATION WELDER used to weld sandwhich structures of polypropylene honeycomb structures of the above described types between two polypropylene plate substrates. In this regard, one side of honeycomb structure 52 (FIG. 7) is vibration welded to one of the polypropylene plates 54 and the other polypropylene plate 54 then vibration welded to the other side of the honeycomb structure (sandwich). The honeycomb structures were 10 and 20 mm thick and the polypropylene plates were 20% MFR (mineral filled) and 30% talc filled. (Honeycomb material with 10 mm and 20 mm thickness (70 mm×700 mm))

TABLE 2

| | Fre- | | Weld | Melt | Hold | Hold | |
|---|---|---|---|---|---|---|---|
| | quency | Amplitude | Force | Time | Force | Time | |
| Part # | [Hz] | [mm] | [N] | [sec] | [N] | [sec] | Comments |
| 1 | 240 | 1.80 | 340 | 8 | 340 | 8 | 10 mm/20% |
| | | | | | | | MFR filled, |
| | | | | | | | sandwhich |
| 2 | 240 | 1.80 | 340 | 8 | 340 | 8 | 20 mm/20% |
| | | | | | | | MFR filled, |
| | | | | | | | sandwhich |
| 3 | 240 | 1.80 | 340 | 5 | 340 | 5 | 10 mm/20% |
| | | | | | | | MFR filled |
| 4 | 240 | 1.80 | 340 | 5 | 340 | 5 | 10 mm/20% |
| | | | | | | | MFR filled |
| 5 | 240 | 1.80 | 340 | 8 | 340 | 5 | 20 mm/20% |
| | | | | | | | MFR filled |
| 6 | 240 | 1.80 | 340 | 8 | 340 | 8 | 20 mm/20% |
| | | | | | | | MFR filled |
| 7 | 240 | 1.80 | 340 | 8 | 340 | 8 | 20 mm/30% |
| | | | | | | | TF filled |
| 8 | 240 | 1.80 | 340 | 8 | 340 | 5 | 20 mm/30% |
| | | | | | | | TF filled |
| 9 | 240 | 1.80 | 340 | 5 | 340 | 5 | 10 mm/30% |
| | | | | | | | TF filled |
| 10 | 240 | 1.80 | 340 | 5 | 340 | 5 | 10 mm/30% |
| | | | | | | | TF filled |

Parts made of materials that are “incompatible” can be vibration or friction welded by adhering, such as by adhesive, a layer or of “compatible” material to one or both parts. As used herein, “compatible” material is material that can be vibration welded to the other part or to the other layer of compatible material, as the case may be. For example, polyurethane foam is a material that has been used to provide the crash pad in energy management structures. However, polyurethane foam is a thermoset material and cannot be effectively vibration or friction welded. To vibration or friction weld a thermoset material such as polyurethane to a thermoplastic material, such as polypropylene, a layer of compatible thermoplastic material, such as a polypropylene sheet, is adhered to the surface of the part made of the thermoset material that is to be welded to the part made of thermoplastic material. The part made of the thermoset material can then be vibration or friction welded to the part made of thermoplastic material by vibration welding the two parts so that the layer of thermoplastic material adhered to the part made of thermoset material is vibration welded to the other part. Two parts made of thermoset material can be similarly welded by vibration or friction welding by first adhering to the surfaces of each part that are to be welded to each other respective layers of compatible thermoplastic material. For example, sheets of polypropylene fleece can be adhered to the surfaces of the respective parts that are to be welded, such as by adhesive. Similarly, parts made of “incompatible” thermoplastics can be vibration welded by adhering to the surface of one or both parts that are to be welded together a layer (or layers as the case may be) of compatible thermoplastic. Incompatible thermoplastics are thermoplastics that have melt temperatures and flow indices that are sufficiently different so as to preclude effective vibration or friction welding of the two materials. Compatible thermoplastics are thermoplastics that have sufficiently similar melt temperatures and flow indices so that two materials can be friction or vibration welded.

Turning to FIG. 4, an exploded view of an energy management structure 38 having a polyurethane crash pad 40 bonded to a headliner 10 is shown. The substrate 42 is illustratively fiber reinforced headliner material of the type described above. Elements in FIG. 4 corresponding to elements in FIG. 3 are identified with like reference numerals. Crash pad 40 is illustratively made of a layer of polyurethane foam 44 with a backing layer of polyester fleece or polypropylene 46 adhered to the layer of polyurethane foam 44 in known fashion, such as with adhesive or adhesive tape. Crash pad 40 may optionally also have a facing layer 48, which can be felt, polyester fleece, or the like.

Headliner 10 is placed in vibration welding apparatus 20 (FIG. 3) in the manner described above and crash pad or pads 40 placed on crash pad fixtures 34 (FIG. 3) with polyester backing layer 44 facing toward headliner 10. Headliner 10 and crash pad(s) 40 are then vibration welded together in the manner described above.

Table 3 shows welding parameters for structures made by welding on a Branson Ultrasonics MINI-VIBRATION WELDER pieces of typical polyester backed headliner material to a layer of polyurethane foam having a polypropylene fleece backing layer as described above. In the Welds of Table 3, the thermoplastic material from the polypropylene fleece backing layer of the crash pad penetrates the polyester backing layer 14 of headliner 10 forming a mechanical bond. In each case, a bond was achieved. The optimum weld parameters would illustratively be determined heuristically. (Polyurethane parts with polypropylene fleece backing approx. 10 mm thick and 60 mm×15 mm)

TABLE 3

| | | | Weld | Time/ | Hold | Hold |
|---|---|---|---|---|---|---|
| Part | Frequency | Amplitude | Force | Melt | Force | Time |
| No. | [Hz] | [mm] | [N] | [sec] | [N] | [sec] |
| 1 | 240 | 1.70 | 340 | 6 sec. | 340 | 3 |
| 2 | 240 | 1.70 | 340 | 6 sec. | 340 | 3 |
| 3 | 240 | 1.70 | 340 | 8 sec. | 340 | 3 |
| 4 | 240 | 1.70 | 340 | 8 sec. | 340 | 3 |
| 5 | 240 | 1.70 | 340 | 8 sec. | 340 | 3 |

In some cases, two parts are made from similar material having thermoplastic but not enough to permit effective vibration or friction welding. For example, it is difficult to effectively vibration or friction weld two pieces of the above described headliner material together even though their polyester backing layers are a thermoplastic. In such cases, an intermediate thermoplastic material that can be vibration or friction welded to the two parts is interposed between the two polyester backing layers. The intermediate thermoplastic material can be adhered to one of the parts such as by adhesive or vibration or friction welded to the part. The other part is then vibration or friction welded to the first part, and particularly to the thermoplastic layer adhered to the first part.

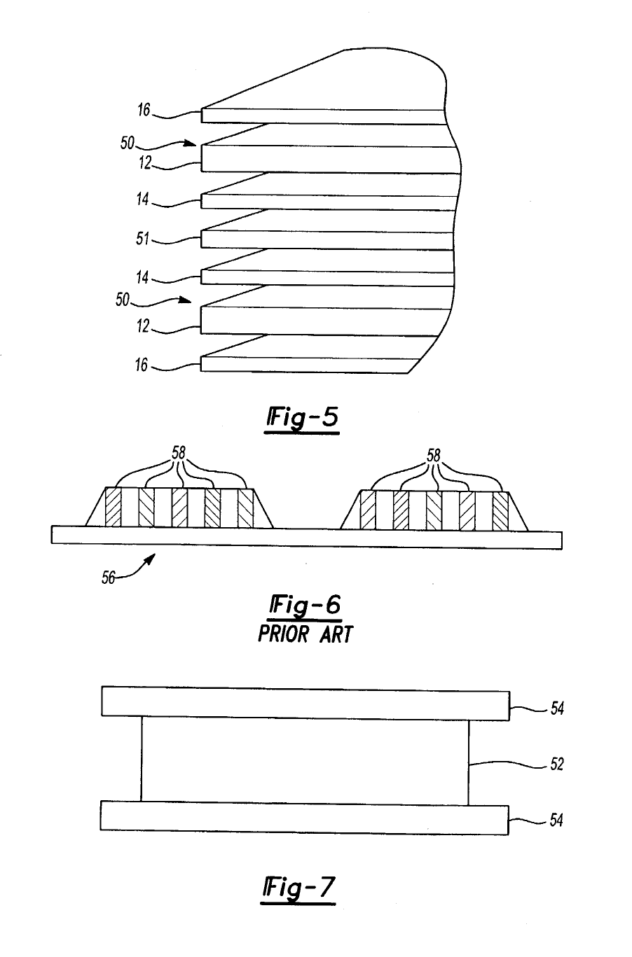

An example where the above described process can be used is to vibration or friction weld two pieces of the above described typical headliner material together. As discussed above, a headliner 50 made of this typical headliner material includes a polyurethane foam layer 12 having a polyester backing sheet 14 and a front sheet 16 of fabric such as felt. Although polyester is a thermoplastic, two layers of polyester typically cannot be effectively friction welded. FIG. 5 is an exploded view of two pieces 50 of such headliner material vibration or friction welded by interposing a layer polypropylene film 51 between the polyester backing layers 14 of the two pieces of headliner 50. Polypropylene film 51 is bonded to the polyester backing layer 14 of one of the pieces 50 such as by adhesive, adhesive tape, or the like, or by vibration or friction welding. The resulting headliner piece 50 with polypropylene film 51 bonded to its polyester backing layer 14 is then vibration or friction welded to the other piece 50, with the polypropylene film 51 being vibration or friction welded to the polyester backing layer 14 of the other piece 50.

Table 4 shows illustrative welding parameters for a number of welds where two such pieces 50 were vibration or friction welded together in such a manner with a Branson Ultrasonics MINI-VIBRATION WELDER. (Parts approximately 50 mm×50 mm)

TABLE 4

| | | | Weld | Time/ | Hold | Hold |
|---|---|---|---|---|---|---|
| Part | Frequency | Amplitude | Force | Melt | Force | Time |
| No. | [Hz] | [mm] | [N] | [sec] | [N] | [sec] |
| 1 | 240 | 1.70 | 340 | 8 | 340 | 3 |
| 2 | 240 | 1.70 | 340 | 8 | 340 | 3 |
| 3 | 240 | 1.70 | 340 | 4 | 340 | 3 |
| 4 | 240 | 1.70 | 340 | 5 | 340 | 3 |
| 5 | 240 | 1.70 | 340 | 1 | 340 | 3 |

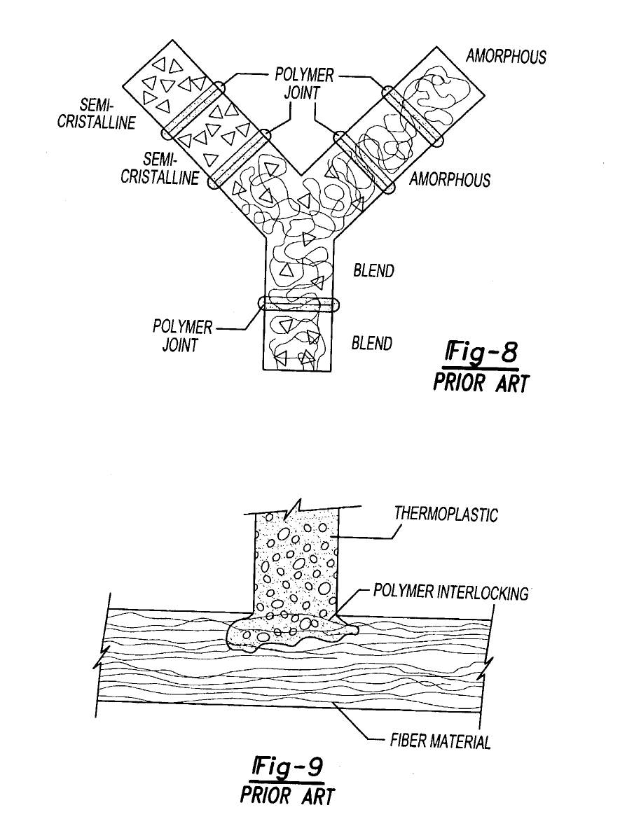

FIG. 8 shows a molecular polymer bond between two parts made of polymers where the polymers adhere to each other. As is known, in a molecular polymer bond, the polymers of the two parts mix and become one polymer. Thus, as is know, to melt two polymers together to form a polymer bond, the two polymers, if not the same polymers, must have comparable melt temperatures and melt flow indices.

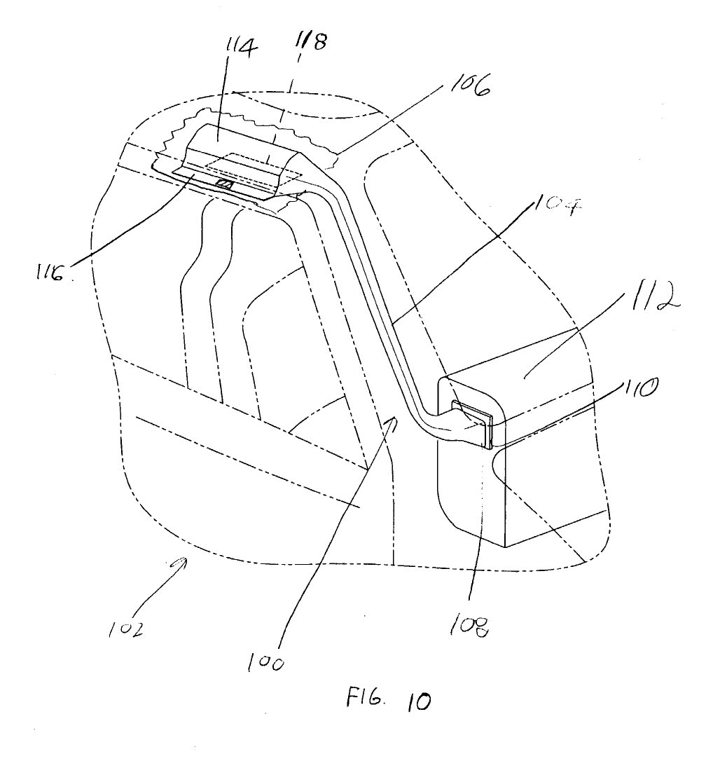

FIG. 9 shows a mechanical or interlocking bond formed by melting the polymers of two parts together. In a mechanical bond, the polymers of one part, such as thermoplastic part melt and interlock around elements in the polymer of the other part, such as fiber material. However, in a pure mechanical bond, the polymers of the two parts do not intermix as described above with reference to the molecular polymer bond of FIG. 8.

Table 5 shows welding parameters for a Branson Ultrasonic Vibration Welder Type VW4 used to weld a honeycomb material (Type “WAVE CORE” with fleece backing on both sides from Trauma Lite) to headliner material with a polypropylene backing (Type “AZDEL” from the Lear Corporation). Parts are welded together with a strip therebetween for pull-tests. (Honeycomb material Type “WAVE CORE”, 15 mm thick with fleece backing, part size 70×120 mm. Headliner material Type “AZDEL” with polypropylene backing, part size 200×150 mm.)

TABLE 5

| | | | Weld | Time/ | Hold | Time/ | Melt | |
|---|---|---|---|---|---|---|---|---|
| Part | Frequency | Amplitude | Force | Melt | Force | Hold | Down | |
| No. | [Hz] | [mm] | [N] | [sec] | [N] | [sec] | [mm] | Comments |
| 1 | 240 | 1.75 | 1134 | 3 | 1134 | 5 | 0.092-0.11 | Moving: |
| | | | | | | | | honeycomb |
| | | | | | | | | Holding: headliner |
| 2 | 240 | 1.75 | 1588 | 5 | 1588 | 5 | 0.070-0.080 | Moving: headliner |
| | | | | | | | | Holding: |
| | | | | | | | | honeycomb |
| 3 | 240 | 1.75 | 907 | 5 | 907 | 5 | 0.020 | Moving: headliner |
| | | | | | | | | Holding: |
| | | | | | | | | honeycomb |
| 4 | 240 | 1.75 | 907 | 5 | 907 | 5 | 0.030-0.050 | Moving: |
| | | | | | | | | honeycomb |
| | | | | | | | | Holding: headliner |
| 5 | 240 | 1.75 | 907 | 4 | 907 | 4 | 0.011-0.013 | Moving: headliner |
| | | | | | | | | Holding: |
| | | | | | | | | honeycomb |
| 6 | 240 | 1.75 | 907 | 4 | 907 | 4 | 0.015-0.016 | Moving: |
| | | | | | | | | honeycomb |
| | | | | | | | | Holding: headliner |
| 7 | 240 | 1.75 | 680 | 4 | 680 | 4 | 0.002-0.003 | Moving: headliner |
| | | | | | | | | Holding: |
| | | | | | | | | honeycomb |
| 8 | 240 | 1.75 | 680 | 4 | 680 | 4 | 0.006-0.008 | Moving: |
| | | | | | | | | honeycomb |
| | | | | | | | | Holding: headliner |
| 9 | 240 | 1.75 | 1360 | 3 | 1360 | 3 | 0.011 | Moving: headliner |
| | | | | | | | | Holding: |
| | | | | | | | | honeycomb |
| 10 | 240 | 1.75 | 1360 | 3 | 1360 | 3 | 0.013-0.014 | Moving: |
| | | | | | | | | honeycomb |
| | | | | | | | | Holding: headliner |

Table 6 shows welding parameters for a Branson Ultrasonic Vibration Welder Type VW4 used to weld a polypropylene safety-plastic (from the Oakwood Group) to headliner material with a polypropylene backing (Type “AZDEL” from the Lear Corporation) and headliner material with a polyester backing (from the Lear Corporation). (Safety Plastic, part size 100×140 mm. Headliner material with polypropylene/polyester-backing, part size 120×160 mm.)

TABLE 6

| | | | Weld | Time/ | Hold | Time/ | |
|---|---|---|---|---|---|---|---|
| Part | | Amplitude | Force | Melt | Force | Hold | |
| No. | Frequency [Hz] | [mm] | [N] | [sec] | [N] | [sec] | Comments |
| 1 | 240 | 1.75 | 1134 | 3 | 1134 | 5 | Moving: safety plastic |
| | | | | | | | Holding: headliner |
| | | | | | | | with PP backing |
| 2 | 240 | 1.75 | 1134 | 3 | 1134 | 5 | Moving: safety |
| | | | | | | | plastic |
| | | | | | | | Holding: headliner |
| | | | | | | | with PP backing |
| 3 | 240 | 1.75 | 1134 | 3 | 1134 | 5 | Moving: safety |
| | | | | | | | plastic |
| | | | | | | | Holding: headliner |
| | | | | | | | with PE backing |
| 4 | 240 | 1.75 | 1134 | 3 | 1134 | 5 | Moving: safety |
| | | | | | | | plastic |
| | | | | | | | Holding: headliner |
| | | | | | | | with PE backing |

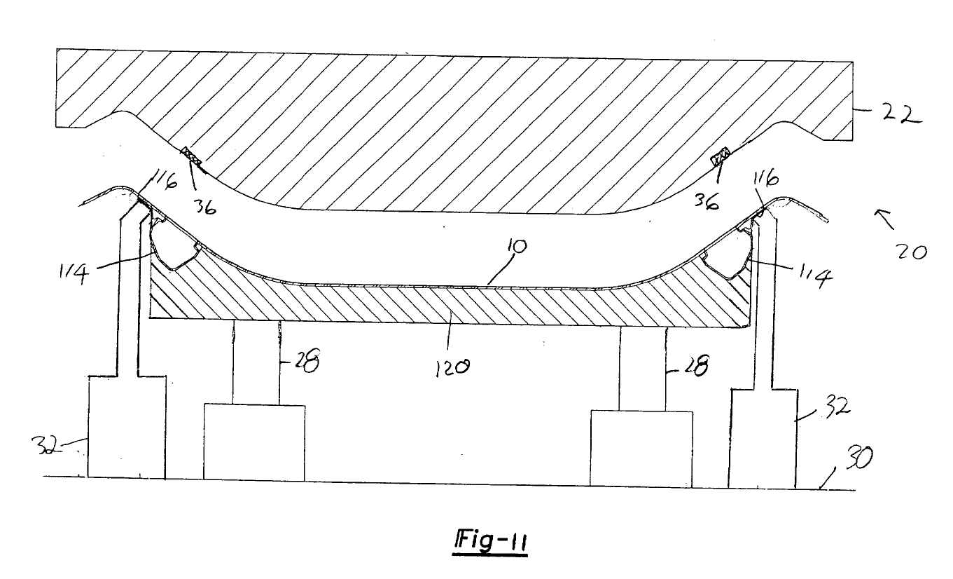

Referring to FIG. 10, a duct/headliner assembly 100 made in accordance with an aspect of the invention is shown installed in a motor vehicle 102. Duct/headliner assembly 100 includes duct 104 bonded to headliner 106. Headliner 106 is illustratively a headliner of the type heretofore described. It should be understood that headliner 106 can be part of an energy management system, such as energy management system 8 described above. Duct/headliner assembly 100 may illustratively include a second duct 104 on the other side of vehicle 102.

Duct 104 is fabricated of plastic, typically polyethylene or polypropylene, in any known manner such as by blow molding. Duct 104 includes an inlet 108 at one end that couples to a HVAC outlet 110 in instrument panel 112 of vehicle 102. Duct 104 also includes a plenum 114 at its other end and a welding flange 116, illustratively adjacent to and extending from plenum 110. Plenum 110 has an opening 118 therein that opens into the passenger compartment of vehicle 102 through a corresponding opening in headliner 106.

Duct 104 is bonded to headliner 106 by vibration welding or by ultrasonic welding. Vibration welding duct 104 to headliner 106 is done in a manner similar to that described above.

FIG. 11 shows ducts 104 and headliner 106 in vibration welding apparatus 20 (FIG. 3). Elements common between FIGS. 3 and 10 are identified with the same reference number and only the differences will be described. Appropriate portions of ducts 104, such as plenums 114 and welding flanges 116, are placed in a fixture 120. Headliner 106 is then placed in fixture 120 over the portions of ducts 104 in fixture 120 with the visible (fabric layer 16) of the headliner 106 face up.

The welding cycle of vibration welding apparatus 20 is then initiated. Table 30 raises cylinders 28 and pressure zones 32, bringing headliner 106 into upper tool 24 with pressure zones 32 forcing welding flanges 116 against headliner 106. If headliner 106 is not part of an energy management system, such as energy management system 8, then welding flanges 116 are forced against the backing layer of headliner 106, which is illustratively a polypropylene or polyester backing layer such as backing layer 14 (FIG. 1). If headliner 106 is part of an energy management system, such as energy management system 8, welding flanges 116 are forced either against the crash pads of the energy management system, such as crash pads 18 (FIG. 1), or the polyester backing layer of headliner 106, depending on where the weld flanges of ducts 104 are bonded to energy management system 8.

When headliner 106 or energy management system 8, as the case may be, and duct 104 have been raised into upper tool 24, fixture 120 is lowered. Vibration head 22 is then actuated vibrating welding flanges 116 of ducts 104 against the backing layer of headliner 106 or crash pad 18 of energy management system 8 of which headliner 106 is a part, as applicable. This vibration welds the welding flanges of ducts 104 to the backing layer of headliner 106 or the crash pads 18 of energy management system 8. Roughened inserts 36 are positioned in upper tool 24 so that they are opposite welding flanges 116 of ducts 104 when headliner 106 or energy management system 8 has been raised into upper tool 24. Upon completion of the vibration weld cycle, vibration welding apparatus 20 maintains welding flanges 116 against headliner 106 or crash pads 18 under pressure for an appropriate hold time. Upon expiration of the hold time, table 30 is lowered and the completed duct/headliner assembly 100 is removed from vibration welding apparatus 20.

As discussed above, duct 104 is typically made of polyethylene or polypropylene. The backing layer of headliner 106 is illustratively a polypropylene or polyester backing layer. Also as discussed above, crash pads 18 of energy management system 8 are polypropylene honeycombs. Polypropylene, polyethylene and polyester are compatible materials, as described above, for vibration welding together. However, if the backing layer of headliner 106 is made of material incompatible with the material of which duct 104 is made, then a layer of compatible material (as discussed above) can be adhered to one or both of headliner 106 and duct 104 in the manner described above to permit headliner 106 and duct 104 to be vibration welded together. The same can be done if crash pad 18 is made of material incompatible with the material of which duct 104 is made.

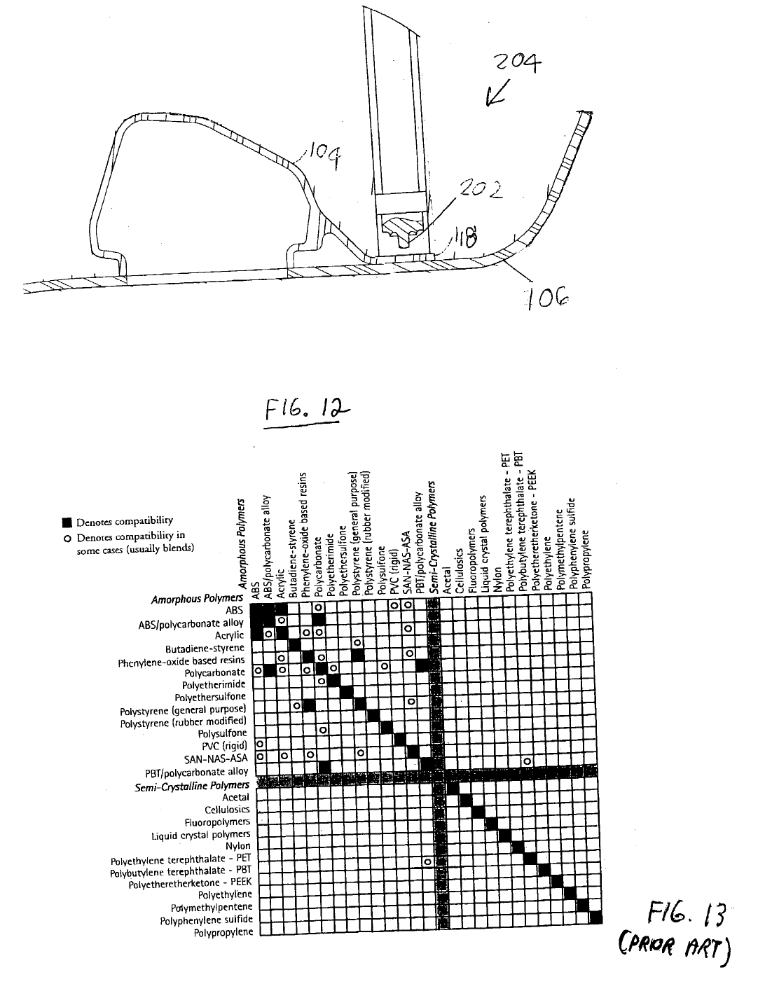

Referring to FIG. 12, another aspect of the invention is described. Elements in common with the elements of FIGS. 10 and 11 will be identified with the same reference numerals. In this aspect of the invention, headliner 106 and duct 104 are welded together using ultrasonic welding. As shown in FIG. 11, headliner 106 is fixtured in ultrasonic welder 200 in conventional fashion. Duct 104 is also fixtured in ultrasonic welder 202 so that welding flange 116 butts against the portion of headliner 106 to which duct 104 is to be bonded. Welding tip 202 of ultrasonic welder 200 is brought into contact with welding flange 118 of duct 104 and ultrasonic welder 200 energized. This ultrasonically welds welding flange 116 of duct 104 to the backing layer of headliner 106. Alternatively, headliner 106 could be part of an energy management system, such as energy management system 8 (FIG. 3). In which case, welding flange 116 of duct 104 is butted up against at least one of crash pad 18 and the backing layer of headliner 106 and ultrasonically welded thereto.

Ultrasonic welder 200 can illustratively be an ultrasonic spot welder available from Branson Ultrasonics of Danbury, Conn.

It should be understood that the configuration of duct 104 shown in FIGS. 10-12 is illustrative and that duct 104 can have other configurations.

As is known, to ultrasonically weld two materials together, they must be “compatible” in much the same sense as described above with reference to vibration welding. That is, the two materials must have similar melt temperatures and like molecular structures. In this regard, the backing layer of headliner 106 is illustratively made of polypropylene when duct 104 is made of polypropylene. The backing layer may also be made of polyester when duct 104 is made of polypropylene, however this results in a mechanical or partial bond and not a complete homogeneous bond.

Parts made of materials that are “incompatible” can be ultrasonically welded by adhering, such as by adhesive, a layer or of “compatible” material to one or both parts. As used herein, “compatible” material is material that can be ultrasonically welded to the other part or to the other layer of compatible material, as the case may be. FIG. 13 is a chart showing compatibility of materials for ultrasonic welding. The chart of FIG. 13 depicts compatibility as a complete mixing of materials resulting in a homogenous bond. Other combinations of materials may be used to create mechanical or partial bonds.

To ultrasonically weld incompatible materials, such as polypropylene to a material shown in FIG. 13 as being incompatible with ultrasonic welding to polypropylene, a layer of compatible material, such as a polypropylene sheet, is adhered to the surface of the part made of the incompatible material. The part made of the incompatible material can then be ultrasonically welded to the part made of polypropylene by ultrasonically welding the two parts so that the layer of polypropylene material adhered to the part made of incompatible material is ultrasonically welded to the part made of polypropylene. In this regard, a layer of compatible material, such as polypropylene, can first be adhered to the surface of each part as opposed to just one part. The foregoing method can be advantageously utilized to ultrasonically weld headliner 106 to duct 104 should headliner 106 and duct 104 be made of incompatible materials for ultrasonic welding together.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of bonding a plastic duct to a headliner for a vehicle comprising vibration welding at least one portion of the duct to at least one portion of the headliner.

2. The method of claim 1 wherein the duct includes at least one welding flange and vibration welding the at least one portion of the duct to the at least one portion of the headliner includes vibration welding at least one portion of the welding flange to the at least one portion of the headliner.

3. The method of claim 2 wherein at least the welding flange of the duct is made of one of polyethylene and polypropylene and the at least one portion of the headliner is made of one of polyester and polypropylene.

4. The method of claim 3 wherein the at least one portion of the headliner is a portion of a backing layer of the headliner.

5. The method of claim 1 wherein the headliner is part of an energy management system including the headliner and a crash pad adhered to the headliner, the at least one portion of the duct being vibration welded to at least one portion of at least one of the crash pad and a backing layer of the headliner.

6. The method of claim 2 wherein the headliner is part of an energy management system including the headliner and a crash pad adhered to the headliner, the welding flange of the duct being vibration welded to at least one portion of at least one of the crash pad and a backing layer of the headliner.

7. The method of claim 6 wherein the welding flange is made of one of polyethylene and polypropylene and the crash pad is made of polypropylene.

8. The method of claim 4 wherein the welding flange and the backing layer are made of incompatible materials, the method including adhering a layer of compatible material compatible to one of the welding flange and backing layer to at least the portion of the other of the welding flange and backing layer that is vibration welded prior to vibration welding the at least one portion of the welding flange to the at least one portion of the backing layer.

9. The method of claim 6, wherein at least one portion of the welding flange is vibration welded to at least one portion of the crash pad, the welding flange and crash pad made of incompatible materials, the method including adhering a layer of compatible material compatible to one of the welding flange and crash pad to at least the portion of the other of the welding flange and crash pad that is vibration welded prior to vibration welding the at least one portion of the welding flange to the at least one portion of the crash pad.

10. A headliner and duct assembly comprising a headliner and a plastic duct vibration welded together.

11. The headliner and duct assembly of claim 10 wherein the duct has a welding flange that is vibration welded to the headliner.

12. The headliner and duct assembly of claim 11 wherein the headliner includes a backing layer, the welding flange of the duct being vibration welded to the backing layer of the headliner.

13. The headliner and duct assembly of claim 12 wherein the welding flange of the duct is made of one of polyethylene and polypropylene and the backing layer of the headliner is made of one of polypropylene and polyester.

14. The headliner and duct assembly of claim 10 wherein the headliner is part of an energy management system that includes the headliner and a crash pad and the duct is vibration welded to at least one of the crash pad and a backing layer of the headliner.

15. The headliner and duct assembly of claim 11 wherein the headliner is part of an energy management system that includes the headliner and a crash pad and the welding flange of the duct is vibration welded to at least one of the crash pad and a backing layer of the headliner.

16. A method of bonding a plastic duct to a headliner for a vehicle comprising ultrasonically welding at least one portion of the duct to at least one portion of the headliner.

17. The method of claim 16 wherein the duct includes at least one welding flange and ultrasonically welding the at least one portion of the duct to the at least one portion of the headliner includes ultrasonically welding at least one portion of the welding flange to the at least one portion of the headliner.

18. The method of claim 17 wherein at least the welding flange of the duct is made of one of polyethylene and polypropylene and the at least one portion of the headliner is made of one of polypropylene and polyester.

19. The method of claim 18 wherein the at least one portion of the headliner is a portion of a backing layer of the headliner.

20. The method of claim 16 wherein the headliner is part of an energy management system including the headliner and a crash pad adhered to the headliner, the at least one portion of the duct being ultrasonically welded to at least one portion of at least one of the crash pad and a backing layer of the headliner.

21. The method of claim 17 wherein the headliner is part of an energy management system including the headliner and a crash pad adhered to the headliner, the at least one portion of the welding flange of the duct being ultrasonically welded to at least one portion of at least one of the crash pad and a backing layer of the headliner.

22. The method of claim 21 wherein the welding flange is made of one of polyethylene and polypropylene and the crash pad is made of polypropylene.

23. The method of claim 19 wherein the welding flange and the backing layer are made of incompatible materials, the method including adhering a layer of compatible material compatible to the at least one portion of the welding flange and the at least one portion of the backing layer to the other of the at least one portion of the welding flange and the at least one portion of the backing layer prior to ultrasonic welding.

24. The method of claim 21 wherein the welding flange and the crash pad are ultrasonically welded together and are made of incompatible materials, the method including adhering a layer of compatible material compatible to the at least one portion of the welding flange and the at least one portion of the crash pad to the other of the at least one portion of the welding flange and the at least one portion of the crash pad prior to ultrasonic welding.

25. A headliner and duct assembly comprising a headliner and a duct ultrasonically welded together.

26. The headliner and duct assembly of claim 25 wherein the duct has a welding flange that is ultrasonically welded to the headliner.

27. The headliner and duct assembly of claim 26 wherein the headliner includes a backing layer, the welding flange of the duct being ultrasonically welded to the backing layer of the headliner.

28. The headliner and duct assembly of claim 27 wherein the welding flange of the duct is made of one of polyethylene and polypropylene and the backing layer of the headliner is made of one of polypropylene and polyester.

29. The headliner and duct assembly of claim 25 wherein the headliner is part of an energy management system that includes the headliner and a crash pad and the duct is ultrasonically welded to at least one portion of one of the crash pad and a backing layer of the headliner.

30. The headliner and duct assembly of claim 26 wherein the headliner is part of an energy management system that includes the headliner and a crash pad and the welding flange of the duct is ultrasonically welded to at least one portion of at least one of the crash pad and a backing layer of the headliner.

31. A method of ultrasonically welding two parts made of incompatible material comprising prior to ultrasonically welding adhering to at least one of the parts compatible material compatible with the other of the parts.

32. The method of claim 31 including adhering layers of compatible material compatible to each other to each of the two parts prior to ultrasonic welding.
